(19) United States
(12) Patent Application Publication
(10) Pub. No.: US 2017/0020162 A1
(43) Pub. Date: Jan. 26, 2017

(54) NUTRITIVE PRODUCT WITH ANIMAL ENSILAGE AND METHOD FOR MAKING THE NUTRITIVE PRODUCT

(71) Applicant: AM NUTRITION AS, Stavanger (NO)

(72) Inventors: Odd Kåre RUGLAND, Vigrestad (NO); Laura Gil MARTENS, Sola (NO)

(73) Assignee: AM NUTRITION AS, Stavanger (NO)

(21) Appl. No.: 15/301,040

(22) PCT Filed: Mar. 26, 2015
(86) PCT No.: PCT/NO2015/050058

§ 371 Date: Sep. 30, 2016

(30) Foreign Application Priority Data
Apr. 2, 2014 (NO) 20140426

(51) Int. Cl. A23K 10/22; A23K 50/40; A23K 40/25; A23K 50/20; A23K 30/00; A23K 10/37

(52) U.S. Cl. CPC A23K 10/22; A23K 30/00; A23K 10/37; A23K 40/25; A23K 50/20; A23K 50/40

(57) ABSTRACT

The invention relates to a mixture for making a cooking-extruded extrudate, the mixture including an aqueous animal ensilage and a vegetable material, and—the aqueous animal ensilage including a water-soluble protein fraction, a water-insoluble protein fraction and fat;—the mixture including from 12.5% by weight or more of ensilage dry matter to 42% by weight or less of ensilage dry matter; and—the mixture including at least 15% by weight of water and less than 34% by weight of water. The invention also relates to a method of making a cooking-extruded extrudate from the mixture. The invention further relates to a use of the cooking-extruded extrudate.

The invention relates to the use of aqueous animal ensilage, especially fish ensilage, as a raw material in the production of a nutritive product. More particularly, the invention relates to a mixture comprising aqueous animal ensilage and a vegetable material. The mixture is cooking-extruded and the extrudate can be used as an intermediate product for the production of an animal feed. The extrudate can also be used directly as an animal feed.

Fish ensilage is fish material that has been acidified to increase its storage stability. The fish material may be cuttings or whole fish. The fish material is mixed together and minced so that a homogenous mass is obtained. The homogenous mass is then acidified to approximately pH 3.0-4.5 by acid being added, for example an inorganic acid such as hydrochloric acid, or an organic acid such as formic acid. The optimum pH value depends on the type of acid used. Through acidification, an inhibition of bacterial growth is achieved. The fish tissue is hydrolyzed by the fish's own enzymes. To accelerate the hydrolysis, the temperature may be increased. The temperature during ensilaging typically lies in the range from 5° C. to an upper limit of about 40° C. The viscosity of the ensilage decreases with increasing temperature. It is desirable for the ensilage to be of low viscosity because it is then easier to pump.

During ensilaging there will be a partial breakdown of important amino acids. It may therefore be beneficial to mix ensilage together with other protein sources to have a desired amino-acid profile.

Fish ensilage is used for, among other things, the production of feeds for domestic animals, such as piglets and poultry, feeds for fur animals, such as foxes or minks, and feeds for pets. Ensilage of white fish may be used to produce feeds for salmonoids. Ensilage of salmonoids is not used to produce feed for salmonoids as there is a possibility that fish-pathogenic bacteria and fish-pathogenic viruses that have not been killed in the ensilaging process and while the ensilage has been stored may cause disease. Infections like that are not transferred to domestic animals and fur animals.

A problem in the commercial utilization of fish ensilage is the physical form of the ensilage. Compared with fish meal, which is dry, fish ensilage is liquid and has a high water content. To be able to utilize the fish ensilage to produce feeds, there is therefore a need for additives which have the ability to bind the moisture present. By binding the moisture, the resulting material can be used further for the production of solid feed products, for example through an extrusion process. It is also desirable to have an additive which has a nutritional value in itself. Particularly desirable are additives that have an amino-acid profile complementary to the protein of the ensilage, so that a feed with a good bioaccessibility of the protein present in the feed is obtained. It is also known to heat ensilage, separate oil from the ensilage and concentrate the remaining ensilage fraction by evaporation so that the dry-matter content will be between 30 and 50%.

From the patent publication WO 1987004051 it is known to mix together raw fish ensilage, wheat meal from whole grain and gelatine for the production of feed pellets. A formulation mentioned in the patent publication consists of 60-70 per cent by volume of raw fish ensilage, 25-30 per cent by volume of wheat meal and 1-3 per cent by volume of gelatine and 3-8 per cent by volume of vitamins and minerals. The formulation is pressed into pellets.

In the production of animal feeds based on ensilage of white fish or of salmonoids, especially in feeds for dogs, it is desirable to avoid using cereal products. The use of cereal products and then wheat in particular is connected with an increased risk of indigestion in dogs. It is also known that the amino-acid profile achieved in the finished product when wheat is used as a binder is not satisfactory. Wheat also has a relatively high glycemic index. The glycemic index is a measurement of how rapidly the blood-sugar level rises after the intake of a food. A high glycemic index in feed is connected with overweight. There is therefore a need to find an alternative to wheat as a binder for fish ensilage.

It is known to add ensilage into a cooking-extrusion process. It is also known that the amount of raw ensilage with a water content of over 50% should not exceed 25 per cent by weight of the total mixture present in the extruder barrel. This is because the amount of water in the mixture makes the mixture too wet. This results in the mixture “lubricating” the extruder so that the necessary pressure build-up fails to occur in the extruder barrel. In addition, the extrudate will not expand on pressure relief at the die openings of the extruder, and the extrudate will be too wet for it to be shaped into pellets.

The dry matter of aqueous animal ensilage will be referred to, in what follows and in the claims, as ensilage dry matter. The dry matter of vegetable material will be referred to, in what follows and in the claims, as vegetable dry matter.

The invention has for its object to remedy or reduce at least one of the drawbacks of the prior art or at least provide a useful alternative to the prior art.

The object is achieved through the features that are specified in the description below and in the claims that follow.

The invention is defined by the independent claim(s). The dependent claims define advantageous embodiments of the invention.

In a first aspect, the invention relates to a mixture for forming a cooking-extruded extrudate, the mixture including an aqueous animal ensilage and a vegetable material, and
the animal ensilage comprising a water-soluble protein fraction, a water-insoluble protein fraction and fat;
the mixture including from 12.5% by weight or more of ensilage dry matter to 42% by weight or less of ensilage dry matter; and
the mixture including at least 15% by weight of water and less than 34% by weight of water.

The mixture can be formed by carrying aqueous animal ensilage and vegetable material separately to a preconditioner, in which the material is mixed. The mixture may alternatively be formed by carrying aqueous animal ensilage and vegetable material separately to an extruder barrel in which the material is mixed.

The ensilage dry matter of the mixture may be obtained by the mixture including more than 25 per cent by weight of animal ensilage with 50% water and by the mixture including less than 60 per cent by weight of animal ensilage with 30% water. The mixture may include 60 per cent by weight of animal ensilage with 50% water.

The water in the mixture comes from the aqueous animal ensilage and from the water content of the vegetable material. The water content of the vegetable material is typically 10% by weight. The water content of the vegetable material may vary between 7% by weight and 13% by weight.

The mixture may include more than 12.5% by weight of ensilage dry matter and less than 35% by weight of ensilage dry matter. The mixture may include more than 15% by weight of ensilage dry matter and less than 35% by weight of ensilage dry matter. This corresponds to the mixture including more than 25 per cent by weight of animal ensilage with 50% water and to the mixture including less than 50 per cent by weight of animal ensilage with 30% water.

The mixture may include more than 36% by weight of vegetable dry matter and less than 67.5% by weight of vegetable dry matter. The mixture may include more than 45% by weight of vegetable dry matter and less than 67.5% by weight of vegetable dry matter. The mixture may include more than 45% by weight of vegetable dry matter and less than 63% by weight of vegetable dry matter.

The vegetable material may include a starchy material selected from a group consisting of cereals, legumes, tubers and bananas. Cereals may include wheat, rye, barley, oats, rice and maize, but are not limited to these cereals. Legumes may include peas, beans, lentils, soya beans and peanuts. Tubers may include the potato, sweet potato and manioc.

The starchy material may include legume-starch-containing material. The legume—starch-containing material may include starch-enriched legume-starch-containing material.

The mixture may include more than 40% by weight of starchy material and less than 75% by weight of starchy material. The mixture may include more than 50% by weight of starchy material and less than 75% by weight of starchy material. The mixture may include more than 50% by weight of starchy material and less than 70% by weight of starchy material.

The vegetable material may include a protein-containing material selected from a group consisting of cereals and legumes. The protein-containing material may include legume-protein-containing material. The legume-protein-containing material may include protein-enriched legume-protein-containing material.

The mixture may include more than 40% by weight of vegetable protein-containing material and less than 75% by weight of vegetable protein-containing material.

The vegetable material may comprise a hull-fibre material produced from a group consisting of cereals and legumes. The hull-fibre material may include hull fibre from legumes. The hull-fibre material includes enriched hull fibre from legumes.

The mixture may include more than 40% by weight of hull fibre and less than 75% by weight of hull fibre.

The animal ensilage may consist of concentrated, fat-reduced animal ensilage. The animal ensilage may include fish ensilage. The fish ensilage may include ensilage produced from white fish. The fish ensilage may include ensilage produced from salmonoids. The animal ensilage may include ensilage of offal from land animals.

In a second aspect, the invention relates to a method of making a cooking-extruded extrudate, the method including:
mixing aqueous animal ensilage, which includes a water-soluble protein fraction, a water-insoluble protein fraction and fat, with vegetable material so that an animal ensilage dry matter constitutes an amount of from 12.5% by weight to 30% by weight of the entire mixture and the mixture contains at least 15% by weight of water;
extruding the mixture in an extruder barrel; and
passing the mixture in the extruder barrel through a die plate at the end portion of the extruder barrel to form an extrudate.

The method may further include:
mixing the aqueous animal ensilage with vegetable material in a preconditioner;
adding steam to the mixture in the preconditioner so that the mixture will have a temperature of between 90° C. and 98° C. out of the preconditioner; and
carrying the mixture from the preconditioner to the extruder barrel.

The method may include selecting a concentrated, fat-reduced animal ensilage.

The method may further include mixing the vegetable material so that a vegetable dry matter constitutes between more than 36% by weight and less than 67.5% by weight of the entire mixture.

The vegetable material may be selected from a group consisting of cereals, legumes, tubers and bananas. The vegetable material may be a starchy material. The vegetable material may be a starch-enriched legume-starch-containing material.

The vegetable material may be a protein-containing material. The protein-containing material may be a protein-enriched legume-protein-containing material.

The vegetable material may be a hull-fibre material. The hull-fibre material may be an enriched hull-fibre material.

The method may further include cutting the extrudate into pellets and drying the pellets.

In a third aspect, the invention relates to a use of the cooking-extruded extrudate, made as described above, as a reward feed for a pet.

The invention is not restricted to the ensilage of fish material. Ensilage of offal material from land animals can be used as well.

The animal ensilage is mixed with a vegetable material. The vegetable material may be a starchy material. In one embodiment, the starchy material may be a pure starch. In particular, the starchy material may be ground. The starchy material may be enriched with respect to starch. Even more particularly, the starchy material may be hulled legumes and enriched with respect to starch. The starchy material may be hulled peas and enriched with respect to starch. The starchy material may also contain proteins.

The starch fraction may be cereal starch from wheat or rice, legume starch as from peas or beans, tuber starch as from potato or manioc, or other starch as from bananas.

Legume starch and especially legume starch from peas is a co-called low-allergenic raw material.

The starchy material may be carried into a so-called preconditioner. The animal ensilage is added to the starchy material in the preconditioner. The mixture is then carried into a co-called cooking-extruder. The cooking-extruder may be a so-called “single-screw” extruder or a so-called “double-screw” extruder. The mass is processed in the extruder barrel and forced out of die openings in the die plate of the extruder. The extrudate can be cut into pellets by a rotating knife. The extrudate can be dried in a dryer, for example a belt dryer or a vertical dryer. In an alternative embodiment, the starchy material, possibly mixed with water or steam, is carried into the extruder barrel and the animal ensilage is added to the starchy material in the extruder barrel.

Twenty-five per cent by weight and more of aqueous animal ensilage may be used in the process. The water content of the ensilage may be between 30% by weight and 50% by weight. Relevant ratios of incorporation may be from 25% by weight of aqueous animal ensilage to 60% by weight of aqueous animal ensilage inclusive into the mixture.

The dried extrudate may be used alone as an animal feed as the animal ensilage is rich in amino acids/peptides/proteins and some fat, whereas the starchy material contains carbohydrates and proteins. The starchy material has a different amino-acid profile from that of the proteins in the ensilage and the two amino-acid profiles may complement each other with respect to the desired amino-acid composition of the extrudate. Such an animal feed will contain relatively little fat and is therefore well suited as a pet feed as, for example, a so-called reward feed or treat.

The dried extrudate can also be used as a protein-containing intermediate product for making an animal feed. A dry extrudate has beneficial qualities with respect to transport, storing and dosing. Such an intermediate product may be mixed with other dry raw materials, possibly by the intermediate product being ground together with some of the other dry raw materials, in order then to be carried into a shaping machine such as a cooking-extruder or a pellet press.

### EXAMPLE 1

Use of Enriched Starch from Peas

Starchy material in the form of pellets was provided. According to the manufacturer's data sheet, the starchy material had the following composition: protein: 14-17%, starch: 53-59%, fat: 1-4%, food fibre: 1.5-3%, ash: 1-3%, other carbohydrates: 4.5-17.5%, water 9.5-12.5%. The raw material for the starch was peas (Pisum sativum). The percentages are stated as per cent by weight of the product as is, also called wet basis. The vegetable dry-matter content was 87.5-90.5%. The starchy material was enriched with respect to starch by means of the air-classification method.

### Ensilage

Concentrated aqueous animal ensilage of fish was provided. The animal ensilage had the following composition: protein: 35%, fat: 4%, ash: 6%, formic acid: 4%. The ensilage dry-matter content was 50%. The percentages are stated as per cent by weight of the product as is, also called wet basis. According to the manufacturer's product data sheet, the protein had a protein digestibility of 91% measured in minks. The mineral content was: calcium: 0.7%, phosphorous: 0.8%, sodium: 0.5% and potassium: 0.6%.

Starchy material and aqueous ensilage were carried separately into a so-called pre-conditioner and mixed in the preconditioner together with steam, so that the mixture had a temperature of between 90° C. and 98° C. out of the preconditioner. The mixture was carried into an extruder barrel in a manner known per se. Per 100 kg of mixture the mixture was composed of 60 kg pea-starch-containing material and 40 kg ensilage of fish. The mixture was processed in a so-called cooking-extruder of the single-screw type. Before steam was added, the mixture contained approximately 20% ensilage dry matter, approximately 54% vegetable dry matter and approximately 26% water. The extruder has a capacity of 8 tonnes of extrudate per hour.

The mixture in the extruder barrel of the cooking-extruder was heated to a temperature of between 110° C. and 130° C. The pressure in the extruder barrel depends on the mixture, the screw configuration and the open area of the die plate, among other things, and will typically be between 15 and 30 bar. The die plate was provided with a plurality of holes with a diameter of 5 mm. The mixture expanded a lot after having passed the die plate, and the extrudate had a diameter of more than 10 mm.

The extrudate was cut with a rotating knife into pellets. The pellets were dried at about 80° C. for 60 minutes on a belt dryer divided into zones.

The finished dried extrudate had a moisture content of between 7 and 9% by weight.

An analysis of one production batch showed that the finished dried pellets showed the following nutritional composition: protein: 24.7%, fat: 2.8%, ash 3.6%. The moisture content was 7.0% water.

The example also shows that it is possible to make a product with an adequate protein composition and with a low fat content. The product is well suited as a reward feed for pets and for horses. The product is also well suited as an intermediate product for making an animal feed.

After drying, the product may be packed in a package size which is suitable for selling in a shop to the consumer market. This can be done for a product of the pet-reward-feed type. As an alternative, after drying, the product may be packed in for example 20-kg bags or in so-called big bags which can hold for example 500 kg, 750 kg or 1000 kg. This may be done for a product that is to be used as an ingredient in the production of animal feeds. In an alternative method, the product may be granulated in a manner known per se before being packed into bags or big bags.

### EXAMPLE 2

Use of Enriched Protein from Peas

Protein-enriched material in the form of pellets was provided. According to the manufacturer's data sheet, the protein-enriched material had the following composition: protein: 53-57%, starch: 2.5-7%, fat: approximately 2%, food fibre: 1.7-5%, ash: 5.5-7.5%, other carbohydrates: 3.5-22.6%. The water content was 10-12%. The dry-matter content was 88-90%. The raw material for the protein-enriched material was peas (Pisum sativum). The percentages are stated as per cent by weight of the product as is. The protein-enriched material was enriched with respect to protein by means of the air-classification method.

The animal ensilage was the same as that used in example 1.

Protein-enriched material and aqueous ensilage were introduced separately into a so-called preconditioner and mixed in the preconditioner together with steam, so that the mixture had a temperature of between 90° C. and 98° C. out of the preconditioner. The mixture was carried into an extruder barrel in a manner known per se. Per 100 kg of mixture the mixture was composed of 60 kg protein-enriched material and 40 kg aqueous ensilage of fish. The mixture was processed in the same extruder as that of example 1. Before the addition of steam, the mixture contained approximately 20% ensilage dry matter, approximately 54% vegetable dry matter and approximately 26% water.

The mixture in the extruder barrel of the cooking-extruder was heated to a temperature of between 110° C. and 130° C. The pressure in the extruder barrel depends on the mixture, the screw configuration and the light opening of the die plate, among other things, and will typically be between 15 and 30 bar. The die plate was provided with a plurality of holes with a diameter of 5 mm. The mixture expanded a lot after having passed the die plate, and the extrudate had a diameter of more than 10 mm.

The extrudate was cut with a rotating knife into pellets. The pellets were dried at about 80° C. for 60 minutes on a belt dryer divided into zones.

The finished dried extrudate had a moisture content of between 9 and 13% by weight.

An analysis of one production batch showed that the finished dried pellets showed the following nutritional composition: protein: 47.9%, fat: 3.85%, ash: 6%, fibre: 2%.

The moisture content was 13.0% water.

Example 2 also shows that it is possible to make a product with an adequate protein composition and with a low fat content. The product is well suited as a reward feed for pets and for horses. The product is also well suited as an intermediate product for making an animal feed.

After drying, the product may be packed in a package size which is suitable for selling in a shop to the consumer market. This can be done for a product of the pet-reward-feed type. As an alternative, after drying, the product may be packed in, for example, 20-kg bags or in so-called big bags which can hold for example 500 kg, 750 kg or 1000 kg. This may be done for a product that is to be used as an ingredient in the production of animal feeds. In an alternative method, the product may be granulated in a manner known per se before being packed into bags or big bags.

### EXAMPLE 3

### Use of Enriched Hull Fibre From Peas

Enriched hull fibre in the form of flakes was provided. According to the manufacturer's data sheet, the enriched hull-fibre material had the following composition: dietary fibre: approximately 80-90%, protein: approximately 3-6%, starch: approximately 4-5%, fat: approximately 0.5-1%, ash: approximately 3%, oligopolysaccharides: approximately 4-5%. The water content was approximately 10%. The raw material for the hull fibre was peas (Pisum sativum). The percentages are stated as per cent by weight of the product as is. The enriched hull-fibre material was enriched by means of the air-classification method. The insoluble fibre fraction consists of cellulose (65-70%), hemicelluloses (5%), lignin (<1%). The soluble fibres are represented mainly by pectin and pectin substances like homogalacturonans, rhamnogalacturonan I, rhamnogalacturonan II and xylogalacturonans. The amount of soluble fibre may vary between 16 and 21%.

The animal ensilage was the same as that used in example 1.

Enriched hull-fibre material and ensilage were carried separately into a so-called pre-conditioner and mixed in the preconditioner together with steam, so that the mixture had a temperature of between 90° C. and 98° C. out of the preconditioner. The mixture was carried into an extruder barrel in a manner known per se. Per 100 kg of mixture the mixture was composed of 60 kg enriched hull-fibre material and 40 kg ensilage of fish. The mixture was processed in a so-called cooking-extruder of the single-screw type.

The mixture in the extruder barrel of the cooking-extruder was heated to a temperature of between 110° C. and 130° C. The pressure in the extruder barrel depends on the mixture, the screw configuration and the light opening of the die plate, among other things, and will typically be between 15 and 30 bar. The die plate was provided with a plurality of holes with a diameter of 5 mm. The mixture expanded a lot after having passed the die plate, and the extrudate had a diameter of more than 10 mm.

The extrudate was cut with a rotating knife into pellets. The pellets were dried at about 80° C. for 60 minutes on a belt dryer divided into zones. The finished dried extrudate had a moisture content of between 7 and 9% by weight.

An analysis of one production batch showed that the finished dried pellets showed the following nutritional composition: fibre: 36.5%, protein: 17.8%, fat: 2.8%, ash: 4.3%,. The moisture content was 6.0% water.

Example 3 also shows that it is possible to make a product with an adequate product composition and with a low fat content. The product is well suited as a reward feed for pets and for horses. The product is also well suited as an intermediate product for making an animal feed.

After drying, the product may be packed in a package size which is suitable for selling in a shop to the consumer market. This can be done for a product of the pet-reward-feed type. As an alternative, after drying, the product may be packed, in for example, 20-kg bags or in so-called big bags which can hold for example 500 kg, 750 kg or 1000 kg. This may be done for a product that is to be used as an ingredient in the production of animal feeds. In an alternative method, the product may be granulated in a manner known per se before being packed into bags or big bags

It should be noted that all the above-mentioned embodiments illustrate the invention, but do not limit it, and persons skilled in the art will be able to form many alternative embodiments without departing from the scope of the attached claims. The use of the verb “to comprise” and its various forms does not exclude the presence of elements or steps that are not mentioned in the claims. The indefinite article “a” or “an” before an element does not exclude the presence of more such elements.

The fact that some features are specified in mutually different dependent claims, does not indicate that a combination of these features cannot be used with advantage.

1-31. (canceled)

32. A mixture for making a cooking-extruded extrudate, the mixture including an aqueous animal ensilage and a vegetable material, characterized in that
the aqueous animal ensilage includes an aqueous protein fraction, a water-insoluble protein fraction and fat;
the mixture includes from 12.5% by weight or more of ensilage dry matter to 42% by weight or less of ensilage dry matter; and
the mixture includes at least 15% by weight of water and less than 34% by weight of water.

33. The mixture according to claim 32, wherein the mixture includes more than 12.5% by weight of animal ensilage dry matter and less than 35% by weight of ensilage dry matter.

34. The mixture according to claim 32, wherein the vegetable material includes a starchy material selected from a group consisting of cereals, legumes, tubers and bananas.

35. The mixture according to claim 34, wherein the starchy material includes legume-starch-containing material.

36. The mixture according to claim 35, wherein the legume-starch-containing material includes starch-enriched legume-starch-containing material.

37. The mixture according to claim 32, wherein the vegetable material includes a protein-containing material selected from a group consisting of cereals and legumes.

38. The mixture according to claim 37, wherein the protein-containing material includes legume-protein-containing material.

39. The mixture according to claim 38, wherein the legume-protein-containing material includes protein-enriched legume-protein-containing material.

40. The mixture according to claim 32, wherein the vegetable material comprises a hull-fibre material produced from a group consisting of cereals and legumes.

41. The mixture according to claim 40, wherein the hull-fibre material includes hull fibre from legumes.

42. The mixture according to claim 41, wherein the hull-fibre material includes enriched hull fibre from legumes.

43. The mixture according to claim 32, wherein the mixture includes more than 36% by weight of vegetable dry matter and less than 67.5% by weight of vegetable dry matter.

44. A method of making a cooking-extruded extrudate, characterized in that the method includes:
mixing aqueous animal ensilage which includes a water-soluble protein fraction, a water-insoluble protein fraction and fat, with vegetable material so that an animal ensilage dry matter constitutes an amount of from 12.5% by weight to 42% by weight inclusive of the entire mixture, and the mixture contains at least 15% by weight of water and less than 34% by weight of water;
extruding the mixture in an extruder barrel; and
passing the mixture in the extruder barrel through a die plate at the end portion of the extruder barrel to form an extrudate.

45. The method according to claim 44, wherein the method further includes:
mixing the aqueous animal ensilage with vegetable material in a preconditioner;
adding steam to the mixture in the preconditioner so that the mixture will have a temperature of between 90° C. and 98° C. out of the preconditioner; and
carrying the mixture from the preconditioner to the extruder barrel.

46. The method according to claim 44, wherein the method includes selecting a fat-reduced aqueous animal ensilage.

47. The method according to claim 45, wherein the method includes selecting a fat-reduced aqueous animal ensilage.
